(19) United States
(12) Patent Application Publication
(10) Pub. No.: US 2026/0122337 A1
(43) Pub. Date: Apr. 30, 2026

(54) IMAGE CAPTURING APPARATUS, IMAGE CAPTURING METHOD, AND STORAGE MEDIUM

(71) Applicant: CANON KABUSHIKI KAISHA, Tokyo (JP)

(72) Inventor: KAZUHISA SHIRAYAMA, Tokyo (JP)

(21) Appl. No.: 19/357,343

(22) Filed: Oct. 14, 2025

(30) Foreign Application Priority Data
Oct. 24, 2024 (JP) 2024-187228

(51) Int. Cl. H04N 23/63; H04N 23/60; H04N 23/695; G03B 17/14

(52) U.S. Cl. CPC H04N 23/633; H04N 23/64; H04N 23/695; G03B 17/14

(57) ABSTRACT

An image capturing apparatus includes at least one memory storing instructions; and at least one processor executing the stored instructions causing the image capturing apparatus to capture an image via a lens; acquire lens information for the lens; control an image capturing direction in which the image is captured; when the image capturing direction is registered as a preset, create a thumbnail image based on an image that has been acquired by capturing the image; and change a display state of the thumbnail image based on comparison results for the lens information for the lens from when the preset was registered, and mounted lens information for a mounted lens that is currently mounted on the image capturing apparatus.

### BACKGROUND

### Field of the Technology

The present disclosure relates to an image capturing apparatus, an image capturing method, a storage medium, and the like.

### Description of the Related Art

Pan-tilt-zoom (PTZ) cameras have a function referred to as a preset function in which the PTZ is rapidly called to a pre-determined position by setting a PTZ position in advance. In recent years, there has been a design in these preset functions such that a user is able to understand at one glance the PTZ position and angle of view that have been registered as a preset by storing an image that has been image captured at the time of preset registration as a thumbnail image, and displaying this image.

However, there are cases in which the angle of view of the thumbnail image from the time of the registration the preset and the actual angle of view are different. For example, in a PTZ camera with interchangeable lenses, in a case in which the focal length from the time of the registration the preset cannot be realized by a lens after it has been changed, the angle of view of the thumbnail image from the time of the registration the preset and the actual angle of view will become different.

In relation to this, Japanese Unexamined Patent Application, First Publication No. 2008-22260 discloses a configuration that updates the thumbnail images by periodically performing image capturing after the camera has been moved to the PTZ position that has been registered for the preset. In addition, Japanese Unexamined Patent Application, First Publication No. 2009-164885 also discloses a configuration that makes it possible to update the thumbnail images by re-acquiring the images when the preset is called and when the camera is started up.

However, in the configurations that are disclosed in Japanese Unexamined Patent Application, First Publication No. 2008-22260 and Japanese Unexamined Patent Application, First Publication No. 2009-164885 it is necessary to re-acquire the thumbnail images that have been registered for the presets, and therefore, time is taken to update the thumbnail images, and this becomes complex. In addition, there is the problem that regardless of there being cases in which the angle of view for the thumbnail image from the time of the registration of the preset cannot be realized if the lens is changed after the preset has been registered, the user may not realize this.

### SUMMARY

The present disclosure is directed to provide an image capturing apparatus in which it is easy to understand the angle of view of a thumbnail image from the time of the registration of a preset even after the lens has been changed.

The image capturing apparatus according to an aspect of the present disclosure includes at least one memory storing instructions; and at least one processor executing the stored instructions causing the image capturing apparatus to capture an image via a lens; acquire lens information for the lens; control an image capturing direction in which the image is captured; when registering the image capturing direction as a preset, create a thumbnail image based on an image that has been acquired by the capturing of the image; and change a display state of the thumbnail image based on comparison results for the lens information from when the preset was registered, and mounted lens information for a mounted lens that is currently mounted on the image capturing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a functional block diagram showing a configurational example of the image capturing apparatus according to an embodiment of the present disclosure.

FIG. 2 is a flowchart showing a processing example for the time of the registration of a preset according to an embodiment of the present disclosure.

FIG. 3A is a flowchart showing a processing example for the time of a lens information comparison during an image capturing method according to an embodiment of the present disclosure.

FIG. 3B is flowchart showing a processing example that is a continuation of FIG. 3A.

FIG. 4A to FIG. 4D are diagrams showing notification display examples according to an embodiment of the present disclosure.

FIG. 5 is a diagram showing examples of displays of a difference in angles of view according to an embodiment of the present disclosure.

### DESCRIPTION OF THE EMBODIMENTS

Below, embodiments of the present disclosure will be explained with reference to the figures. However, the present disclosure is not limited to the following embodiments. Note that in each figure, members or elements that are the same have been given the same reference numerals, and redundant explanations will be omitted or simplified.

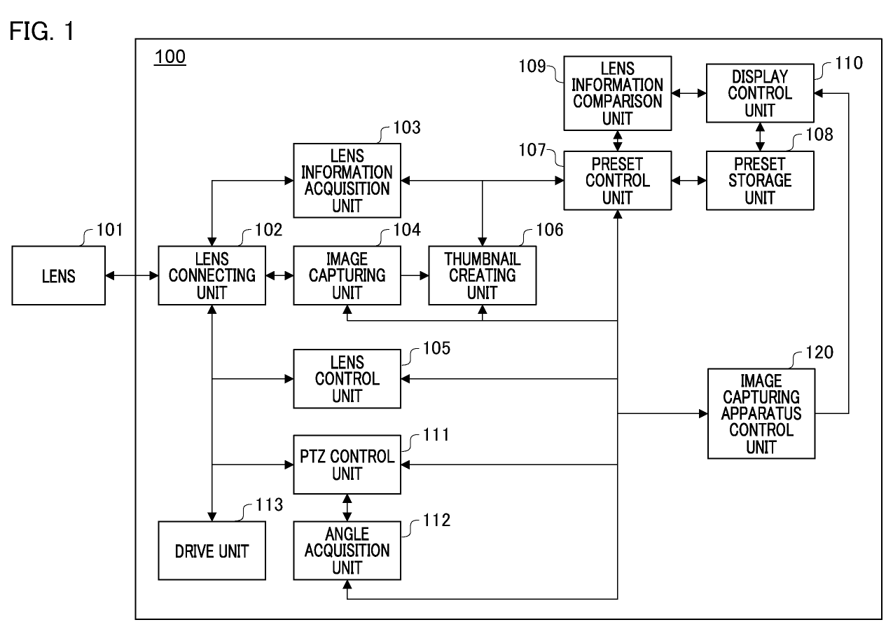

FIG. 1 is a functional block diagram showing a configurational example of an image capturing apparatus according to an embodiment of the present disclosure. Note that a portion of the blocks that are shown in FIG. 1 are realized by a CPU, and the like that serves as a computer, which is not shown and is included in the image capturing apparatus, executing a computer program that has been stored on a memory that serves as a storage medium, which is also not shown.

However, a portion or the entirety thereof may also be realized by hardware. As the hardware, an application-specific integrated circuit (ASIC), a processor (a reconfigurable processor, a DSP), and the like, can be used. In addition, each of the functional blocks that are shown in FIG. 1 do not need to be housed in the same body, and may also be configured by separate apparatuses that have been connected to each other via signal paths.

An image capturing apparatus 100 of the present embodiment is set on a pan/tilt base that is not shown, and is able to perform panning, tilting, and zooming (below, PTZ). In addition, it is possible to interchangeably mount a lens 101 on the image capturing apparatus 100. Note that the image capturing apparatus 100 may also include the lens 101.

In addition, the image capturing apparatus 100 has a lens connecting unit 102, a lens information acquisition unit 103, an image capturing unit 104, a lens control unit 105, a thumbnail creating unit 106, a preset control unit 107, and a preset storage unit 108.

In addition, the image capturing apparatus 100 has a lens information comparison unit 109, a display control unit 110, a PTZ control unit 111, an angle acquisition unit 112, a PTZ drive unit 113, an image capturing apparatus control unit 120. Note that the arrows in the diagrams schematically show a data bus, and each functional block is connected by a data bus, and it is possible to perform mutual data exchanges via data bus with other functional blocks than the functional blocks that have been connected by the arrows in FIG. 1.

The image capturing apparatus control unit 120 is a unit that integrally controls the image capturing apparatus system, and also controls a lens control unit 105, a preset control unit 107, the display control unit 110, the PTZ control unit 111, and the like that will be described below.

In addition, the image capturing apparatus control unit 120 has a CPU that serves as a computer, a RAM, and a ROM. The ROM stores each type of computer program to be operated by the CPU, and the like.

The image capturing apparatus control unit 120 may also have, for example , a hard disk (HD) in addition to the RAM and the ROM. For example, the CPU executes a computer program that is stored on the ROM, uses the RAM as a work memory, and performs various processing, and the control of each unit of the image capturing apparatus.

The lens 101 of the present embodiment is also referred to as an interchangeable lens unit, and has an image capturing optical system including a fixed lens, a zoom lens, an aperture, a focus lens, and the like. The aperture is driven by an aperture drive unit that is not shown, and controls the amount of incident light on an image capturing element to be explained below.

The focus lens is driven by a focus lens drive unit that is not shown, and performs focal point adjustment. The zoom lens is driven by a zoom lens drive unit that is not shown, and thereby performs zoom magnification adjustment. Note that the lens 101 may also be a lens that does not have a zoom function (a monofocal lens). Note that the lens 101 may also include a teleconverter.

The lens connecting unit 102 is able to electrically connect the interchangeable lens 101 and the image capturing apparatus 100 via an electrical connection point and the like that is not shown, and the image capturing apparatus 100 and the lens 101 perform communications with each other via the lens connecting unit 102.

During these communications, drive commands for zooming and focusing are transmitted to the lens 101, data such as an operation state, optical information, and the like from inside the image capturing apparatus 100 and the lens 101 is transmitted and received, and the like. Note that the communications between the lens 101 and the image capturing apparatus 100 may be wireless communications, or the they may also be communications that use light.

The lens information acquisition unit 103 acquires lens information from the ROM and the like inside of the lens 101 via the lens connecting unit 102. Note that the above-described lens information includes a lens model, a lens type (for example, a multifocal lens, a fisheye lens, a telephoto lens, and the like), information about the presence or absence of a range of focal lengths including a tele-end and wide end and a teleconverter, settings information such as the state of switches, and the like. That is, the lens information in the present embodiment includes information relating to the lens type, the focal length, and a movable range for the focal length including a tele-end and a wide end.

The image capturing unit 104 has an image capturing element such as a CCD (charge coupled device), a CMOS (complementary metal oxide semiconductor), an image sensor, and the like.

The image capturing unit 104 generates an image capturing signal by capturing (photoelectrically converting) images via the lens 101. In addition, the image capturing signal that is generated by the image capturing unit 104 is converted into an image signal (a still image, and a video image) by performing each type of image processing on the image capturing signal using image processing circuits, and stored on an image storage unit that is not shown.

The lens control unit 105 includes an operating member, and the user is able to perform operations to the aperture, the focus, the zoom, and the like by operating the operating member. The lens control unit 105 performs control of the lens 101 via the lens connecting unit 102 according to user operations.

In addition, the lens control unit 105 performs control of the aperture drive unit, the focus lens drive unit, and the zoom lens drive unit according to control commands and control information that have been received from the image capturing apparatus control unit 120. Furthermore, the lens control unit 105 transmits lens information (for example, manual focus operations information, information with respect to the image capturing optical system) to the image capturing apparatus control unit 120.

The thumbnail creating unit 106 has an image processing block for creating thumbnail images, an image processing block for segmenting images, and the like that include image processing circuits that perform each type of image processing on the image capturing signal that has been generated in the image capturing unit 104, and convert this into an image signal.

The preset control unit 107 acquires the current pan/tilt angle information for the image capturing apparatus 100 from the angle acquisition unit according to the control commands and control information that have been received from the image capturing apparatus control unit 120. In addition, the preset control unit 107 acquires current zoom information from the lens information acquisition unit 103.

Furthermore, the preset control unit 107 combines the thumbnail that was created in the thumbnail creating unit 106 with the above-described pan/tilt angle information, the zoom information, and the like, and stores one combination (one set) on the preset storage unit 108 to serve as preset information.

In addition, for example, the preset control unit 107 acquires the preset information from the preset storage unit 108 in a case in which a preset function that has been registered is called via the image capturing control unit 120 by a user. In addition, the preset control unit 107 sends a control command to the PTZ control unit 111 so as to realize the PTZ position for this information.

Note that in this context, a preset function indicates a function that is able to realize a desired state with respect to the image capturing state such as the pan, tilt, zoom, and the like by storing this state in advance. Note that the preset function in the present embodiment further includes a trace function.

The trace function is a function that stores operational history data such as panning, tilting, zooming, and the like that have been performed by the user within a set period of time on the preset storage unit 108. The operational history data (trace recording data) for the trace function that has been stored on the preset storage unit 108 is able to recreate the operational history such as panning, tilting, zooming and the like that have been performed by the user by performing a playback at an arbitrary timing.

In the trace function, it is possible to store a replay start position for replaying the trace recording on the preset storage unit 108 in addition to the operational history data by the user for within a set period of time. In addition, when replaying the trace recording, in a case in which there has been a command to move the replay start position, replay of the operational history data (trace recording data) is performed after having moved to the replay start position that has been stored in the preset storage unit 108.

Note that in the case of the trace function, the thumbnail image may also be an image of the angle of view at the initial position, for example, this may also be an image of the angle of view at a variation point at which the pan and tilt movements change. Note that although an example has been explained in which the thumbnail image is acquired at time of the registration of the preset, it is made such that the thumbnail image is also acquired at the time of the registration of the trace recording in the same manner in the trace function.

The preset storage unit 108 stores each combination of preset information and transmits each combination of preset information that has been stored to the preset control unit 107 according to the control commands and control information that have been received from the preset control unit 107.

The lens information comparison unit 109 acquires the lens information for the time of the preset that has been stored on the preset storage unit 108 according to the control commands and the control information that have been received from the preset control unit 107. In addition, the lens information comparison unit 109 acquires the currently mounted lens information from the lens information acquisition unit 103. In addition, the lens information comparison unit 109 compares the lens information for the time of the preset with the currently mounted lens information.

Note that the lens information is, for example a lens model, a lens type (for example, a multifocal lens, a fisheye lens, a telephoto lens, and the like), a range of a focal length including a tele-end and wide end of the lens, a focal length that has been stored in a preset, information about the presence or absence of a teleconverter, and the like

The display control unit 110 acquires the information for the preset that has been stored from the preset storage unit 108 according to the control commands and control information that has been received from the image capturing apparatus control unit 120. In addition, the display control unit 110 performs control of the editing and display of display data for displaying the preset information in relation to a display-use device, and the like that is not shown.

That is, the display control unit 110 is able to edit the display contents for the thumbnail, and control the display based on the results of a comparison in the lens information comparison unit.

The PTZ control unit 111 outputs a PTZ drive command, and controls the drive of the PTZ drive unit 113, which is to be explained below, in order to control the PTZ drive of the image capturing apparatus 100 according to the control commands and control information that have been received from the image capturing apparatus control unit 120.

Note that the PTZ control unit 111 functions as an image capturing direction control unit that realizes an image capturing direction control step in which the image capturing direction of the image capturing unit 104 is controlled. Note that although in the present embodiment, the PTZ control unit 111 that functions as the image capturing direction control unit is able to control both the panning and the tilting, it is sufficient if the image capturing direction control unit controls at least one direction from among the pan direction and the tilt direction.

The angle acquisition unit 112 acquires angle information for the current pan/tilt for the image capturing apparatus 100 from the PTZ control unit 111, along with acquiring the current zoom information from the lens information acquisition unit 103.

The PTZ drive unit 113 is a drive unit that rotates the image capturing apparatus 100 in the pan direction and the tilt direction and a drive unit that drives the zoom of the lens 101 via the lens connecting unit 102, and includes a motor for changing the image capturing direction and the zoom position of the image capturing apparatus 100.

In addition, the pan/tilt drive is provided with a pan rotational-use motor and a tilt rotational-use motor, and these motors perform rotational drive by rotating. Furthermore, each of the motors are provided with an encoder such as a pulse encoder, and the like, and it is possible to detect the rotational positions of the motors.

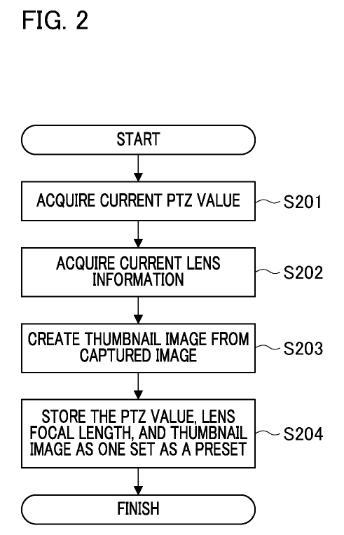

Next, the flow of the processing that is executed by the image capturing apparatus control unit 120, which controls the entirety of the image capturing apparatus 100, will be explained. FIG. 2 is a flowchart showing a processing example from the time of the registration of the preset according to an embodiment of the present disclosure, and shows an example of a processing flow that is executed when a preset is registered in the image capturing apparatus control unit 120.

Note that the processing for the flowchart in FIG. 2 is realized by the CPU, which serves as a computer of the image capturing apparatus control unit 120 that controls the image capturing apparatus 100, executing a computer program according to the present embodiment.

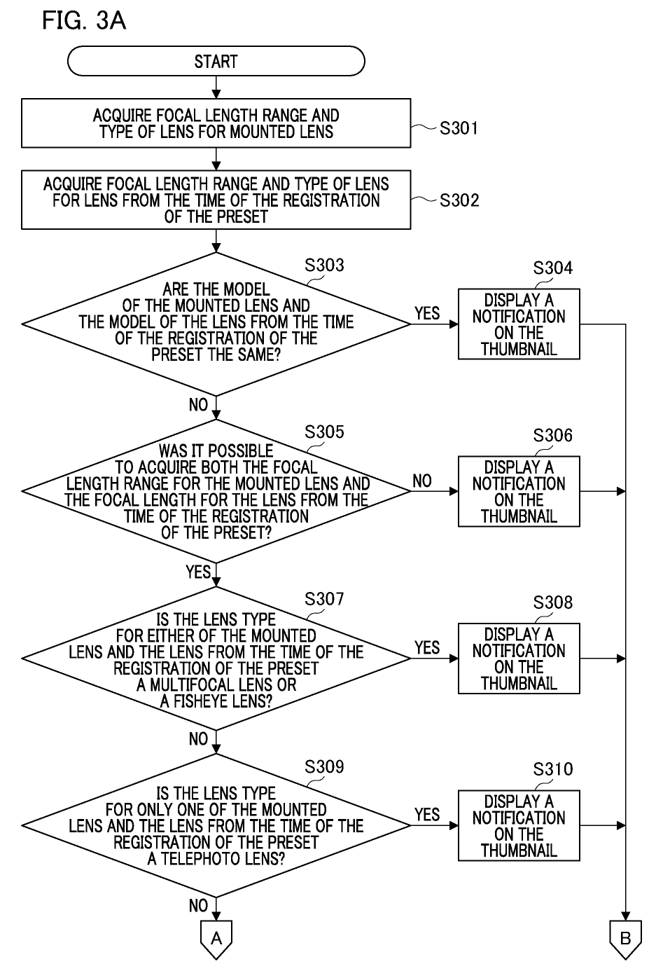

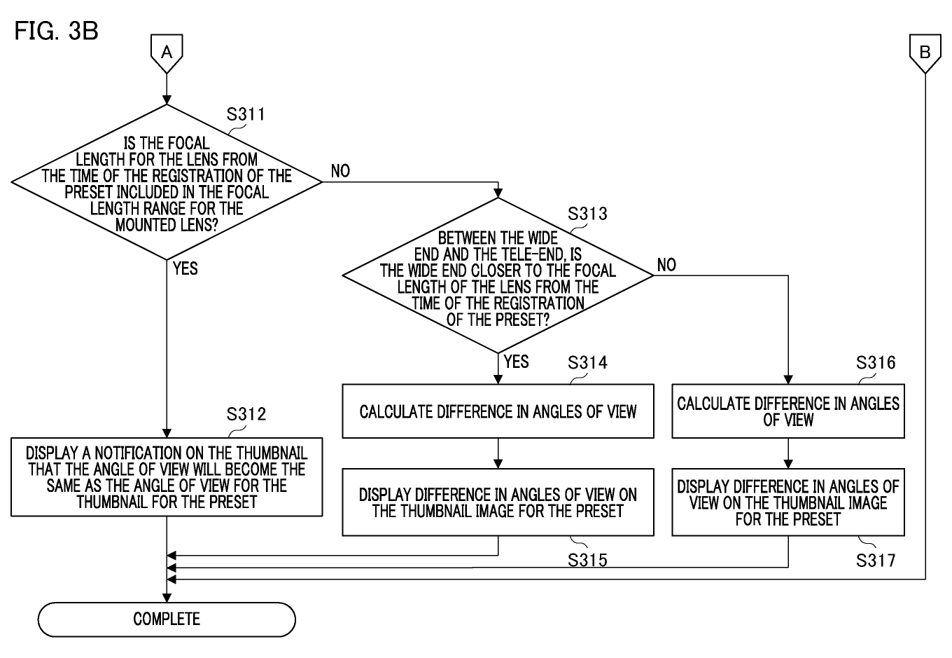

Note that the entirety of the processing of the flowchart in FIG. 2 may be realized by a hardware configuration, and a portion of the processing may also be performed by a hardware configuration while the remaining processing is executed by a software configuration by a program. In addition, the above-described explanation of FIG. 2 also applies in the same manner to the processing for the flowcharts in FIG. 3A, and FIG. 3B to be explained below.

First, during step S201, the image capturing apparatus control unit 120 acquires the current PTZ value for the image capturing apparatus 100, that is, the PTZ position, from the angle acquisition unit 112, and stores this on the preset control unit 107. After this, the image capturing apparatus control unit 120 proceeds to the processing for step S202.

During step S202, the image capturing apparatus control unit 120 acquires the current lens information from the lens information acquisition unit 103 and stores it on the preset control unit 107. Note that step S202 functions as a lens information acquisition step for acquiring lens information for a lens. After the processing for step S202, the image capturing apparatus control unit 120 proceeds to the processing for step S203.

In this context, the lens information that is stored is, for example a lens model, a lens type (for example, a multifocal lens, a fisheye lens, a telephoto lens, and the like), a range of a focal length including a tele-end and wide end of the lens, a focal length that has been stored in a preset, information about the presence or absence of a teleconverter, and the like.

During step S203, a thumbnail image is created from the captured image. That is, the image capturing apparatus control unit 120 captures an image in the current pan/tilt/zoom state from the image capturing unit 104, the thumbnail creating unit 106 creates a thumbnail based on this information, and the thumbnail is stored on the preset control unit 107.

In this context, step S203 functions as a thumbnail creation step during which the thumbnail creation unit 106 creates a thumbnail image based on the image that has been acquired from the image capturing unit when the image capturing direction has been registered as a preset.

After this, the image capturing control unit 120 proceeds to the processing for step S204. Note that there is no particular limitation on the order of the processing for step S201 to step S203.

During step S204, the image capturing apparatus control unit 120 saves the PTZ value, the lens information, and the thumbnail image that were stored on the preset control unit 107 during step S201 to step S203 on the preset storage unit 108 as the preset information for one set (one group). After this, the image capturing apparatus control unit 120 ends the processing flow for registering a preset of FIG. 2.

Note that in a case of a trace recording, the entirety of the processing from step S201 to step S204 may be performed a plurality of times. However, in this case, the processing for step S202 and step S203 does not necessarily need to be performed each time.

FIG. 3A is flowchart showing a processing example for the time of lens information comparison during the image capturing method according to the present embodiment of the present disclosure, and FIG. 3B is a flowchart showing an example of processing that is a continuation of FIG. 3A. That is, FIG. 3A, and FIG. 3B show examples of processing flows in the image capturing apparatus control unit 120 that are executed when the lens information from the time of the registration of the preset and the lens information for the lens that is currently mounted on the image capturing apparatus are compared. Note that in the image capturing method according to the current embodiment, an image is captured via the lens.

Note that in FIG. 3A, and FIG. 3B, an example is shown in which as the lens information, information relating to the lens type and information relating to the focal length are used. This processing may also be executed for example, when the lens is changed. That is, when the lens is exchanged, a comparison is performed of the lens information from when the preset was registered and the lens information for the mounted lens that is currently mounted on the image capturing apparatus, and the display state of the thumbnail image may be changed according to the comparison results.

Conversely, the user may also execute the above-described processing at an arbitrary timing, and this may also be executed at the timing at which the preset information is displayed on the display device, and the like. In addition, in a case in which a plurality of preset data is registered, the processing for FIG. 3A and FIG. 3B may also be performed for each piece of preset data. In addition, this may also be performed for a portion of the preset data within the preset data that has been registered, and this may also be performed for the entirety of the preset data.

In addition, in this case, there are no particular limitations on the preset data to which the above-described processing is applied and the preset data to which the processing not applied, and in addition, there are no particular limitations on the order of the processing for the preset data to which this processing is applied.

First, during step S301, the image capturing apparatus control unit 120 acquires information for the range of the focal length and the lens type for the lens that is currently mounted on the image capturing apparatus from the lens information acquisition unit 103 via the preset control unit 107.

Note that the information that is acquired during step S301 may be both of the information for the range of the focal length of the lens and the type of the lens, and this information may also be one of the range of the focal length of the lens and the type of lens. Note that although in a case in which the currently mounted lens is a monofocal lens, the range of the focal length will become the one value for the focal length of the monofocal lens, in this case, this focal length will later be processed as a wide end and tele-end. After this, the image capturing apparatus control unit 120 proceeds to the processing for step S302.

During step S302, the image capturing apparatus control unit 120 acquires the information for the focal length and the lens type for the lens from the time at which the preset was registered from the preset storage unit 108 via the preset control unit 107.

In this context as well, the information that is acquired may be both the information for the lens focal length and the lens type, and the information that is acquired may also be one of the information for the lens focal length, and the information for the lens type. After this, the image capturing apparatus control unit 120 proceeds to the processing for step S303.

During step S303, it is determined whether or not the model of the lens that has been mounted on the image capturing apparatus and the model of the lens at the time of the registration of the preset are the same. That is, the image capturing apparatus control unit 120 determines whether or not the model of the lens that is currently mounted on the image capturing apparatus that was acquired during step S301 and the model of the lens from the time at which the preset was registered that was acquired during step S302 are the same using the lens information comparison unit 109.

In a case in which it has been determined that these are the same, the processing proceeds to step S304, and in a case in which it has been determined that these are not the same, the processing proceeds to step S305. Note that the image capturing apparatus control unit 120 may also make the processing proceed to step S305 without performing the processing for step S303.

During step S304, a notification is displayed on the thumbnail image. That is, the image capturing apparatus control unit 120 performs a display, via the display control unit 110, on the thumbnail image of the preset information that is displayed on the display-use device and the like of a notification that the lens model that is currently mounted on the image capturing apparatus is the same as the lens model from the time of the registration of the preset.

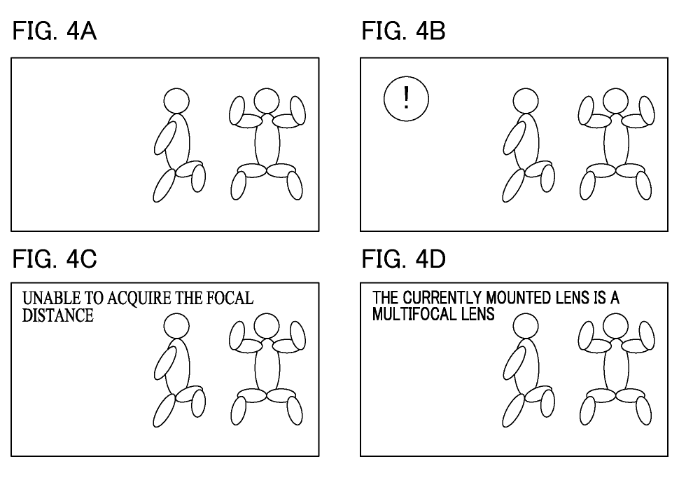

FIG. 4A to FIG. 4D are diagrams showing examples of notification displays according to an embodiment of the present disclosure. FIG. 4A shows an original thumbnail image, and FIG. 4B to FIG. 4D show examples of notification displays for each of step S304, step S306, and step S308.

It is sufficient if the notification display during step S304 is a display that is different than the thumbnail image that was originally displayed, and, for example, text showing that this is the same model of lens, and, for example, an icon as is shown in FIG. 4B may also be displayed.

In addition, as other examples, a box may also be displayed on the outer side of the thumbnail image, the color of this box may be changed, it may be made such that the thumbnail image is not displayed, or the thumbnail image may also be displayed as flashing. Conversely, the size of the thumbnail image may also be changed, and the color of the thumbnail image may also be changed.

After step S304, the image capturing apparatus control unit 120 completes the processing flow that is shown in FIG. 3A, and FIG. 3B for comparing the lens information for the lens that is currently mounted on the image capturing apparatus with the lens information from the time at which the preset was registered.

In contrast, during step S305, it is determined whether or not both of the focal length range for the currently mounted lens and the focal length for the lens at the time of the registration of the preset were able to be acquired. That is, the image capturing apparatus control unit 120 determines whether or not both of the range for the focal length of the currently mounted lens that was acquired during step S301 and the focal length for the lens from the time of the registration of the preset that was acquired during step S302 were able to be acquired via the preset control unit 107.

In a case in which it has been determined that they were both able to be acquired, the processing proceeds to step S307, and in a case in which it has been determined that they were not both able to be acquired, the processing proceeds to step S306. Note that the image capturing apparatus control unit 120 may also proceed to the processing for step S307 without performing the processing for step S305.

In addition, in a case in which the processing for acquiring the range of the focal length for the lens has not been performed during step S301, and in a case in which the processing for acquiring the focal length of the lens at the time of the registration of the present has not been performed during step S302, the processing proceeds to step S307 without performing the determination for step S305.

During step S306 a notification display is performed on the thumbnail image. That is, the image capturing apparatus control unit 120 performs, on the thumbnail image for the preset information that is displayed on the display-use apparatus, and the like, a display that notifies the user that No was determined during step S305 via the display control unit 110.

It is sufficient if the notification display during step S306 is a display that is different than the thumbnail image that was originally displayed, and, for example, text or an icon may also be displayed such as that in FIG. 4C showing that the focal length information could not be acquired.

That is, in a case in which the focal length for the lens from the time of the registration of the preset could not be acquired, and, in a case in which the movable range for the focal length of the currently mounted lens could not be acquired, the display state of the thumbnail image may also be changed,

Conversely, a box may also be displayed on the outer side of the thumbnail image, the color of this box may be changed, it may be made such that the thumbnail image is not displayed, the thumbnail image may also be displayed as flashing, the size of the thumbnail image may also be changed, and the color of the thumbnail image may also be changed.

After step S306, the image capturing apparatus control unit 120 completes the processing flow that is shown in FIG. 3A, and FIG. 3B for comparing the lens information for the lens that is currently mounted on the image capturing apparatus with the lens information from the time at which the preset was registered.

During step S307, it is determined whether or not the type of lens that is currently mounted, and the type of lens from the time of the registration of the preset is a multifocal lens, and whether or not the type of lens that is currently mounted, and the type of lens from the time of the registration of the preset is a fisheye lens. That is, the image capturing apparatus control unit 120 determines whether or not neither of the type of lens of the currently mounted lens and the type of lens at the time of the registration of the preset are a multifocal lens and a fish eye lens, and whether or not at least one of these lenses is a multifocal lens, and a fisheye lens.

In a case in which it has been determined that both the lens type for the currently mounted lens and the lens type for the lens from the time of the registration of the preset are not multifocal lenses, and in a case in which it has been determined that both the lens type for the currently mounted lens and the lens type for the lens from the time of the registration of the preset are not fisheye lenses, the processing proceeds to step S309. In addition, in a case in which it has been determined that at least one of these is a multifocal lens, and a case in which it has been determined that at least one of these is a fisheye lens, the processing proceeds to step S308. Note that the image capturing apparatus control unit 120 may also proceed to the processing for step S309 without performing the processing for step S307.

During step S308, the notification display is performed for the thumbnail image. That is, the image capturing apparatus control unit 120 performs a display, on the thumbnail image for the preset notification, that notifies the user that at least one of the lens type for the currently mounted lens and the lens type for the lens from the time of the registration of the preset is a multifocal lens, and that at least one of the lens type for the currently mounted lens and the lens type for the lens from the time of the registration of the preset is a fisheye lens.

In this manner, in the present embodiment, in a case in which at least one of the type of lens from the time of the registration of the preset, and the type of lens for the currently mounted lens is a multifocal lens, and at least one of the type of lens from the time of the registration of the preset, and the type of lens for the currently mounted lens is a fisheye lens, which are comprised of a plurality of lenses, the display state of the thumbnail image is changed.

It is sufficient if the notification display during step S308 is a display that is different than the thumbnail image that was originally displayed, and, for example, text or an icon may also be displayed such as that in FIG. 4D showing that at least one of the lenses is a multifocal lens, and a fisheye lens.

Conversely, a box may also be displayed on the outer side of the thumbnail image, the color of this box may be changed, it may be made such that the thumbnail image is not displayed, the thumbnail image may also be displayed as flashing, the size of the thumbnail image may also be changed, and the color of the thumbnail image may also be changed.

After step S308, the image capturing apparatus control unit 120 completes the processing flow that is shown in FIG. 3A, and FIG. 3B for comparing the lens information for the lens that is currently mounted on the image capturing apparatus with the lens information from the time at which the preset was registered.

During step S309, it is determined whether or not one of the lens type of the currently mounted lens and the lens type of the lens from the time of the registration of the preset is a telephoto lens. That is, the image capturing apparatus control unit 120 uses the lens information comparison unit 109 to determine whether or not just one of the lens type for the currently mounted lens that was acquired during step S301 and the lens type for the lens from the time of the registration of the preset that was acquired during step S302 is a telephoto lens.

In a case in which it has been determined that one of the lens type for the currently mounted lens and the lens type for the lens at the time of the registration of the preset is a telephoto lens, the processing proceeds to step S310, and when this is not the case, the processing proceeds to S311. Note that the image capturing apparatus control unit 120 may also proceed to the processing for step S311 without performing the processing for step S309.

During step S310, the notification display is performed on the thumbnail image. That is, the image capturing apparatus control unit 120 performs a display, on the thumbnail image for the preset information, that notifies the user that only one of the lens type for the currently mounted lens and the lens type for the lens from the time of the registration of the preset is a telephoto lens.

In this manner, in the present embodiment, in a case in which just one of the lens type for the currently mounted lens and the lens type for the lens from the time of the registration of the preset is a telephoto lens, the display state of the thumbnail image is changed.

It is sufficient if the notification display during step S310 is a display that is different than the thumbnail image that was originally displayed, and, for example, text or an icon may also be displayed showing that just one of the lens type for the currently mounted lens and the lens type for the lens at the time of the registration of the preset is a telephoto lens .

Conversely, a box may also be displayed on the outer side of the thumbnail image, the color of this box may be changed, it may be made such that the thumbnail image is not displayed, the thumbnail image may also be displayed as flashing, the size of the thumbnail image may also be changed, and the color of the thumbnail image may also be changed.

After step S310, the image capturing apparatus control unit 120 completes the processing flow that is shown in FIG. 3A, and FIG. 3B for comparing the lens information for the lens that is currently mounted on the image capturing apparatus with the lens information from the time at which the preset was registered.

During step S311, the image capturing apparatus control unit 120 determines whether or not the focal length for the lens from the time of the registration of the preset is included in the range of focal lengths for the currently mounted lens. That is, the image capturing apparatus control unit 120 determines whether or not the focal length for the lens from when the preset registration was performed is included within the movable range for the focal length of the currently mounted lens.

In addition, in a case in which the focal length for the lens from the time of the registration of the preset is included in the range of the focal length for the currently mounted lens, the processing proceeds to step S312, and in a case in which the focal length for the lens from the time of the registration of the preset is not included in the range of focal lengths for the currently mounted lens, the processing proceeds to step S313.

Note that the image capturing apparatus control unit 120 may also complete the processing flow shown in FIG. 3A, and FIG. 3B for comparing the lens information for the time of the registration of the preset with the lens information for the lens that is currently mounted on the image capturing apparatus without performing the processing for step S311.

During step S312, a display is performed on the thumbnail notifying the user that the current angle of view is the same as the angle of view for the preset thumbnail. That is, the image capturing apparatus control unit 120 performs, via the display control unit 110, a display on the thumbnail image for the preset information that is displayed on the display-use apparatus, and the like that notifies the user that the angle of view is the same as the angle of view for the preset thumbnail.

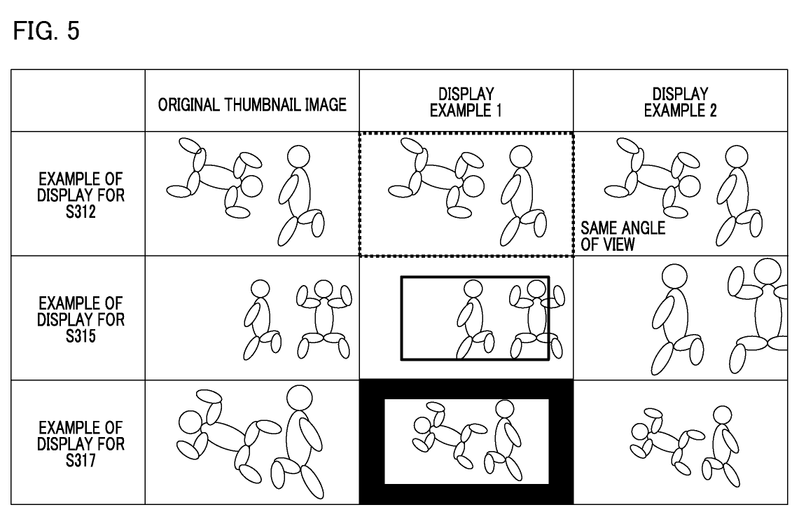

Note that FIG. 5 is a diagram showing an example of a display of the difference in angles of views according to the present embodiment of the present disclosure, and shows the original thumbnail image as well as the display examples therefor from step S312, step S315, and step S317 as a display example 1, and a display example 2. Note that this may also be made a display in which the display example 1 and the display example 2 are both shown together, and this may also be made a display in which only one of the display example 1 and the display example 2 is shown.

It is sufficient if the notification display during step S312 is a display that is different than the thumbnail image that was originally displayed, and, for example, text (for example, the display example 2 for S312 of FIG. 5) or an icon may also be displayed showing that the angle of view will be the same as the angle of view in the preset thumbnail. It is thereby possible for the user to quickly understand that the actual angle of view will be approximately the same as the angle of view in the thumbnail.

Conversely, for example, as is shown in the display example 1 for S312 of FIG. 5, a box may also be displayed on the outer side of the thumbnail image, the color of this box may be changed, it may be made such that the thumbnail image is not displayed, and the thumbnail image may also be displayed as flashing. Conversely, the size of the thumbnail image may also be changed, and the color of the thumbnail image may also be changed.

After step S312, the image capturing apparatus control unit 120 completes the processing flow that is shown in FIG. 3A, and FIG. 3B for comparing the lens information for the lens that is currently mounted on the image capturing apparatus with the lens information from the time at which the preset was registered.

During step S313, the image capturing apparatus control unit 120 determines whether or not from among the tele-end and the wide end of the focal length for the lens that is currently mounted on the image capturing apparatus, the wide end is closer to the focal length for the lens from the time of the registration of the preset. In a case in which Yes has been determined, the processing proceeds to step S314, and in a case in which No has been determined, the processing proceeds to step S316.

During step S314, the image capturing apparatus control unit 120 calculates the difference in angles of view based on the difference between the wide end of the lens that is currently mounted on the image capturing apparatus and the focal length for the lens from the time of the registration of the preset. After this, the image capturing apparatus control unit 120 proceeds to the processing for the step S315.

During step S315, the difference for the angle of view is displayed on the thumbnail for the preset. That is, the image capturing apparatus control unit 120 displays via the display control unit 110 the difference in angles of view that was calculated during step S314 on the thumbnail image for the preset information that is displayed on the display-use apparatus and the like. In this manner, during step S315, the display state of the thumbnail image is changed based on the difference for the angle of view.

The display of the difference in angles of view during step S315 may be any type of display as long as it is different than the thumbnail that was originally displayed. Note that the display of the difference in the angles of view during step S315 may also display a box that shows the angle of view in the wide end of the lens that is currently mounted on the image capturing apparatus on the original thumbnail image such as, for example, the display example 1 for S315 in FIG. 5, based on the difference in angles of view that has been calculated during step S314. It is thereby possible for the user to quickly confirm that the angle of view in the thumbnail is larger than the actual angle of view.

] In addition, a region corresponding to the angle of view in the wide end of the lens that is currently mounted on the image capturing apparatus can be cut out from the thumbnail image and the cut out image may be used as a new substitute for the thumbnail image based on the difference that has been calculated for the angles of view during step S314 (for example, the display example 2 of S315 in FIG. 5). That is, the thumbnail image may be cut out and displayed based on the difference in the angles of view.

Furthermore, text showing that the angle of view in the currently mounted lens is narrower in comparison to the angle of view in the thumbnail image, the numerical difference for the angle of view, and the like may also be shown, and an icon may also be displayed. After step S315, the image capturing apparatus control unit 120 completes the processing flow that is shown in FIG. 3A, and FIG. 3B for comparing the lens information for the lens that is currently mounted on the image capturing apparatus with the lens information from the time at which the preset was registered.

During step S316, the image capturing apparatus control unit 120 calculates the difference in the angles of view based on the difference between the tele-end of the lens that is currently mounted on the image capturing apparatus and the focal length for the lens from the time of the registration of the preset. In this context, step S314, step S316, and step S311 function as calculating units configured to calculate the difference in the angles of view in a case in which the result of the determination during step S311 is No.

That is, step S314 and step S316 calculate the difference in the angles of view from the focal length for the movable limit and the focal length from when the preset was registered using whichever of the tele-end and the wide end of the focal length for the currently mounted lens is closer to the focal length from when the preset was registered as the focal length for the movable limit. After this, the image capturing apparatus control unit 120 proceeds to the processing for step S317.

During step S317, the image capturing apparatus control unit 120 performs a display via the display control unit 110 on the thumbnail image for the preset information that is displayed on the display-use apparatus, and the like of the difference in angles of view that was calculated during step S316.

It is sufficient if the display of the difference of the angles of view during step S317 is different than the thumbnail image that was originally displayed. For example, the region that corresponds to the thumbnail image from among the angle of view in the tele-end of the currently mounted lens can be shrunk and displayed on the thumbnail based on the difference in the angles of view that has been calculated during step S316 (for example, the display example 2 for step S317 in FIG. 5). That is, the thumbnail image may be shrunk and displayed based on the difference in angles of view.

At this time, for example, as is shown in the display example 1 for step S317 in FIG. 5, the region for the difference between the region of the original thumbnail image and the region of the thumbnail image that has been shrunk and displayed may also be made black. In addition, text showing that the angle of view in the currently mounted lens is wider than the angle of view in the thumbnail image, and numbers showing the difference in angles of view may be displayed, and an icon may also be displayed. It is thereby possible for the user to quickly understand that the actual angle of view is larger than the angle of view in the thumbnail.

After step S317, the image capturing apparatus control unit 120 completes the processing flow that is shown in FIG. 3A, and FIG. 3B for comparing the lens information for the lens that is currently mounted on the image capturing apparatus with the lens information from the time at which the preset was registered.

Step S311 to step S317 function as a control step (a control unit) for changing the display state of the thumbnail image based on the comparison results for the lens information for when the preset was registered and mounted lens information for the mounted lens that is currently mounted on the image capturing apparatus.

As has been explained above, in the present embodiment, by performing a display that notifies the user when a lens that is different than the lens that acquired the thumbnail image has been mounted on the image capturing apparatus, and by updating the thumbnail image, it is possible for the user to appropriately determine whether or not it will be possible to re-create the angle of view for the thumbnail. Therefore, in a case in which, for example, it has been determined that the thumbnail image can be re-created, it is possible to call the preset that has been registered.

In addition, in a case in which the angles of view are different, it is possible to notify the user of the difference in angles of view, and therefore, the user can know the angle of view in advance before calling the registered preset, and this reduces user confusion caused by the thumbnails shown when selecting a preset. In addition, it is not necessary to re-acquire a thumbnail image, and it is possible to utilize the thumbnail image that has already been registered.

In addition, even in a case in which the angles of view are different, it is possible to effectively utilize the preset settings after the user has realized that the angles of view are different. In this manner, according to the present embodiment, it is possible to provide an image capturing apparatus that is able to effectively use the preset settings while also reducing confusion caused by the thumbnails from the time of the registration of the presets.

Although above, the present disclosure has been described based on an embodiment, the present disclosure is not limited to the above-described embodiment, and various changes and combinations of the above-described embodiment are possible based on the gist of the present disclosure, and these changes and combinations are not excluded from the scope of the present disclosure. In addition, a portion of the above-described embodiment may also be suitably combined.

In addition, the above-described embodiment can also be applied to each type of apparatus that has been provided with an image capturing function such as a personal computer, a tablet terminal, a smartphone, a portable game device, and the like. In addition, the present disclosure may also be applied to a digital single lens reflex camera, a mirrorless single lens camera, a compact digital camera, a camcorder, a video camera, an onboard camera, a surveillance camera, a medical-use camera, an industrial camera, and the like.

In addition, the present disclosure also includes modes in which, for example, the functions of the above-described embodiment are realized using a processer such as at least one CPU, and the like, a memory, and a circuit (for example, an ASIC). In addition, a plurality of processers may also be used to perform distributed processing.

Note that in order to realize a portion or the entirety of the control in the above described embodiment, it may also be made such that a computer program that realizes the functions of the above-described embodiment are provided to an image capturing apparatus and the like via a network, and via each type of storage medium.

In addition, it may also be made such that the computer (and CPU, MPU, and the like) in this image capturing apparatus and the like reads out and executes this program. In this case, this program, and the storage medium on which this program has been stored configure the present disclosure.

Embodiment(s) of the present disclosure can also be realized by a computer of a system or apparatus that reads out and executes computer executable instructions (e.g., one or more programs) stored on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to realize an image capturing apparatus in which it is easy to understand the angle of view for thumbnail images at the time of the registration of the presets even after the lens has been changed.

This application claims the benefit of Japanese Patent Application No. 2024-187228, filed October 24, 2024, which is hereby incorporated by reference herein in its entirety.

WHAT IS CLAIMED IS:

1. An image capturing apparatus comprising:
at least one memory storing instructions; and
at least one processor executing the stored instructions causing the image capturing apparatus to:
capture an image via a lens;
acquire lens information for the lens;
control an image capturing direction in which the image is captured;
when registering the image capturing direction as a preset, create a thumbnail image based on an image that has been acquired by the capturing of the image; and
change a display state of the thumbnail image based on comparison results for the lens information from when the preset was registered, and mounted lens information for a mounted lens that is currently mounted on the image capturing apparatus.

2. The image capturing apparatus according to claim 1, wherein executing the stored instructions by the processor further causes the image capturing apparatus to control at least one of a pan direction and a tilt direction for the image capturing direction in which the image is captured.

3. The image capturing apparatus according to claim 1, wherein the lens is a zoom lens.

4. The image capturing apparatus according to claim 1,wherein the lens information includes information relating to a lens type for the lens.

5. The image capturing apparatus according to claim 1, wherein the lens information includes information relating to a focal length of the lens.

6. The image capturing apparatus according to claim 5, wherein the lens information includes information relating to a movable range for a focal length including a tele-end and a wide end of the lens.

7. The image capturing apparatus according to claim 1, wherein executing the stored instructions by the processor further causes the image capturing apparatus to determine whether or not a focal length of the lens from when the preset was registered is included within a movable range of a focal length of the mounted lens.

8. The image capturing apparatus according to claim 7, wherein executing the stored instructions by the processor further causes the image capturing apparatus to, in a case in which results of the determination are NO, calculate a difference in angles of view from a focal length of the movable limit and the focal length from when the preset was registered using, as the focal length of the movable limit, whichever of a tele-end and a wide end of the focal length of the mounted lens is closer to the focal length from when the preset was registered.

9. The image capturing apparatus according to claim 8, wherein executing the stored instructions by the processor further causes the image capturing apparatus to change a display state of the thumbnail image based on the difference in the angles of view.

10. The image capturing apparatus according to claim 9, wherein executing the stored instructions by the processor further causes the image capturing apparatus to reduce and display the thumbnail image based on the difference in the angles of view.

11. The image capturing apparatus according to claim 9, wherein executing the stored instructions by further causes the image capturing apparatus to cut out and display the thumbnail image based on the difference in the angles of view.

12. The image capturing apparatus according to claim 1, wherein executing the stored instructions by the processor further causes the image capturing apparatus to, in a case in which the focal length for the lens from when the preset was registered cannot be acquired, and in a case in which a movable limit for the focal length of the mounted lens cannot be acquired, change the display state of the thumbnail image.

13. The image capturing apparatus according to claim 1, wherein executing the stored instructions by the processor further causes the image capturing apparatus to change the display state of the thumbnail image in a case in which a lens type for the lens from when the preset was registered is a lens comprising a plurality of lenses such as a multifocal lens, and a fish eye lens, and in a case in which a lens type for the mounted lens is a lens comprising a plurality of lenses such as a multifocal lens, and a fisheye lens.

14. The image processing apparatus according to claim 1, wherein executing the stored instructions by the processor further causes the image capturing apparatus to change the display state of the thumbnail image in a case in which only one of a lens type for the lens from when the preset was registered, and a lens type for the currently mounted lens is a telephoto lens.

15. The image capturing apparatus according to claim 1, wherein executing the stored instructions by the processor further causes the image capturing apparatus to, when the lens has been exchanged, perform a comparison of the lens information from when the preset was registered, and the lens information for the mounted lens, and change the display state of the thumbnail image based on results of the comparison.

16. An image capturing method for capturing an image via a lens, the image capturing method comprising:
capturing an image via a lens;
acquiring lens information for the lens;
controlling an image capturing direction in which the image is captured;
when registering the image capturing direction as a preset, creating a thumbnail image based on an image that has been acquired by the image capturing; and
changing a display state of the thumbnail image based on comparison results for the lens information from when the preset was registered, and mounted lens information for a mounted lens that is currently mounted on the image capturing apparatus.

17. A non-transitory storage medium storing a program of an image capturing apparatus, causing a computer to perform each step of the image capturing method according to claim 16.
